(19) United States
(12) Patent Application Publication
(10) Pub. No.: US 2026/0341173 A1
(43) Pub. Date: Oct. 29, 2026

(54) SYSTEM AND METHOD FOR DYNAMIC INTEGRATION OF STUDENT INTERESTS INTO PERSONALIZED EDUCATIONAL CONTENT

(71) Applicants: Peter Kraft, Bernardsville, NJ (US); Mark Pontbriant, Bernardsville, NJ (US)

(72) Inventors: Peter Kraft, Bernardsville, NJ (US); Mark Pontbriant, Bernardsville, NJ (US)

(21) Appl. No.: 19/654,420

(22) Filed: Apr. 21, 2026

Related U.S. Application Data
(60) Provisional application No. 63/792,989, filed on Apr. 23, 2025.

(51) Int. Cl. G09B 7/02; G06F 40/40

(52) U.S. Cl. CPC G09B 7/02; G06F 40/40

(57) ABSTRACT

A system and method for enhancing educational content by dynamically integrating student interests into academic explanations. The system collects and categorizes student interests, tracks their usage frequency, and employs a rotation algorithm to select interests for integration into educational content. The method includes dynamically modifying artificial intelligence prompts to incorporate selected interests into explanations while maintaining educational accuracy. The system creates personalized learning experiences that connect academic concepts to individual student interests, resulting in improved engagement and learning outcomes. The invention overcomes the traditional impossibility of manually personalizing educational content for each student's interests at scale, enabling truly individualized learning experiences across diverse student populations and subject areas.

### BACKGROUND

The present invention relates generally to the field of educational technology, and more particularly to systems and methods for personalizing educational content by dynamically integrating student interests into academic explanations.

The field of education faces a fundamental challenge that has persisted since formal instruction began: how to make academic content personally relevant to each individual student. Research in educational psychology consistently demonstrates that students learn most effectively when they can connect academic concepts to their personal interests and real-world contexts.

Traditional classroom instruction, by necessity, delivers standardized content to groups of students simultaneously. Even the most dedicated and skilled educator, when teaching a class of 25-30 students, cannot personalize examples and explanations to incorporate each student's unique interests, hobbies, and career aspirations. This limitation creates several persistent educational challenges:

1. Engagement Gap: Students frequently fail to engage with material they perceive as disconnected from their personal interests, leading to attention deficits and reduced knowledge retention.

2. Relevance Barrier: Without clear connections to their interests or aspirations, students often question the relevance of academic content, asking “When will I ever use this?” This perception barrier significantly impedes motivation and comprehension.

3. Personalization Paradox: While educators recognize the value of personalized learning, the practical constraints of classroom settings make interest-based personalization for each student prohibitively resource-intensive.

4. Representation Limitations: Traditional educational materials contain a limited set of examples that cannot possibly represent the diverse interests of all students, inadvertently privileging some interest domains while neglecting others.

5. Career Connection Gap: Students frequently struggle to see connections between academic subjects and their future career aspirations, reducing motivation and hampering long-term educational commitment.

These challenges are particularly acute in STEM fields, where abstract concepts may seem disconnected from students' everyday experiences and interests. Prior attempts to address these issues have included:

Differentiated instruction techniques, which remain limited by teacher time and resources

Generic adaptive learning systems that adjust difficulty but not context or examples

Content recommendation systems that suggest materials without transforming explanations

The personalization challenge in education represents a fundamental scaling problem that cannot be adequately addressed through conventional teaching methods, regardless of educator skill or commitment. This limitation stems from several immutable constraints:

1. Numerical Impossibility: A typical secondary school teacher instructs approximately 150 students daily across multiple class periods. Even if each student has only 3-5 primary interests, a teacher would need to generate and maintain 450-750 different contextual examples for a single lesson—an impossible cognitive and preparation burden.

2. Knowledge Boundary Constraints: No individual educator possesses sufficient expertise across all potential student interest domains to generate accurate, meaningful examples. A physics teacher may understand skateboarding physics but lack knowledge to create authentic examples for students interested in fashion design, cryptocurrency, or specific music production techniques.

3. Real-time Adaptation Limitations: Classroom instruction proceeds in real-time, requiring immediate responses to questions. Even with thorough preparation, teachers cannot instantaneously reformulate explanations to incorporate each student's unique interests when answering individual questions.

4. Group Context Switching: In group instruction settings, rapid transitions between different student interest contexts would create cognitive dissonance for other students and fragment the coherence of the lesson.

5. Temporal Expansion Effect: Attempting manual personalization for each student would expand instruction time beyond feasible classroom parameters. A 50-minute lesson would require hours to deliver if separately contextualized for each student's interests.

Prior technological solutions have attempted to address these limitations through:
a) Pre-authored content with limited example variations
b) Content recommendation systems that select from existing materials
c) Difficulty adaptation without contextual personalization
d) Generalized “student profiles” based on learning style rather than specific interests

None of these approaches solves the fundamental problem of dynamically generating personalized academic explanations based on each student's unique interest profile. The present invention addresses this previously unsolvable scaling problem through a novel combination of interest profiling, usage tracking, and AI-driven contextual integration that enables truly personalized learning explanations at scale.

### SUMMARY OF THE INVENTION

The present invention provides a system and method for dynamically integrating student interests into personalized educational content. By collecting, categorizing, and tracking student interests and then intelligently incorporating them into academic explanations, the invention creates personalized learning experiences that connect abstract concepts to individual student interests.

In one aspect, the invention includes a method for providing personalized educational content comprising: receiving and storing data representing a plurality of student interests; detecting when a student requests an explanation of an academic concept; selecting an interest from the student's stored interests using a rotation algorithm that prioritizes interests based on usage frequency and recency; modifying an educational prompt to include instructions for incorporating the selected interest; generating a personalized explanation of the academic concept that incorporates the selected interest as a context, example, or analogy; and delivering the personalized explanation to the student.

In another aspect, the invention includes a system for interest-based educational content personalization comprising: a user interface for collecting and managing student interests; a database structure for storing interests and tracking their usage; an interest rotation algorithm that ensures variety in personalization; a prompt engineering module that modifies AI instructions to incorporate selected interests; and an analytics engine that measures the effectiveness of interest integration.

The invention provides several technical advantages, including scalable personalization, efficient interest rotation, memory-efficient storage, adaptive learning curves, cross-domain knowledge transfer, contextual consistency, and distributed knowledge integration. These advantages combine to solve the previously intractable problem of providing truly personalized educational content at scale.

### BRIEF DESCRIPTION OF THE DRAWINGS

FIG. 1 is a block diagram illustrating the overall architecture of the interest integration system according to an embodiment of the present invention.

FIG. 2 is a flowchart illustrating the process of selecting and integrating student interests into educational content according to an embodiment of the present invention.

FIG. 3 is a database schema diagram showing the relationship between user profiles, interest categories, and interest usage tracking according to an embodiment of the present invention.

FIG. 4 is a sequence diagram illustrating the interaction between system components during the interest integration process according to an embodiment of the present invention.

FIG. 5 is a screenshot of a user interface for collecting and managing student interests according to an embodiment of the present invention.

FIG. 6 is a diagram illustrating the prompt engineering process for incorporating selected interests into educational content according to an embodiment of the present invention.

FIG. 7 is a graph showing the correlation between interest integration frequency and student engagement metrics according to an embodiment of the present invention.

FIG. 8 is a diagram of an artificial intelligence content generation process according to an embodiment of the present invention.

FIG. 9 is a flow diagram of the technical implementation of scaling embodiments of the present invention for a large number of users.

FIG. 10 illustrates an artificial intelligence prompt generation process according to an embodiment of the present invention.

FIG. 11 illustrates an interest selection process according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein. Throughout the drawings, like reference numerals refer to like elements.

### System Architecture

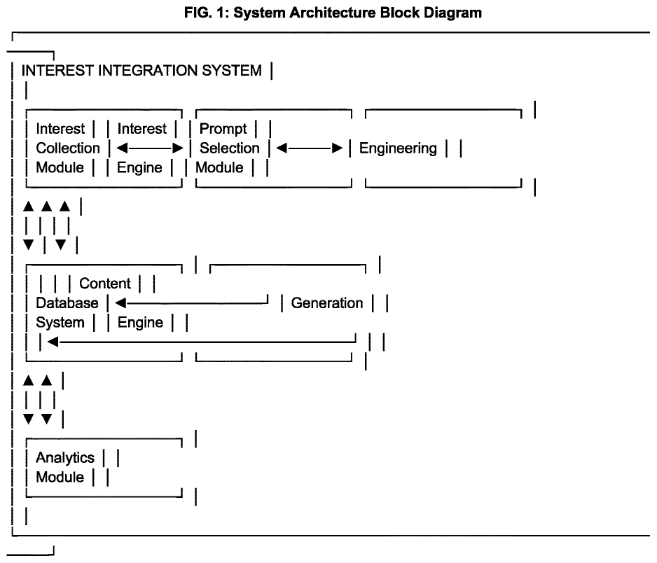

Referring to FIG. 1, a block diagram illustrates the overall architecture of the interest integration system 100 according to an embodiment of the present invention. The system includes an interest collection module 110, a database system 120, an interest selection engine 130, a prompt engineering module 140, a content generation engine 150, and an analytics module 160.

The interest collection module 110 provides a user interface through which students can select and manage their interests across multiple categories. These categories include, but are not limited to, sports, arts, music, technology, careers, hobbies, and academic subjects. The module allows students to indicate primary interests, secondary interests, and career aspirations, with the latter receiving priority weighting in the selection algorithm.

The database system 120 stores student profiles, interest selections, and usage tracking data. It includes tables for user profiles, interest categories, specific interests within each category, and a dedicated interest_usage table that tracks which interests have been used for which students in which educational contexts. This structure enables efficient interest rotation while maintaining data integrity.

The interest selection engine 130 implements the rotation algorithm that determines which interest to incorporate into a given educational explanation.

This algorithm takes into account several factors:
Recency of usage (prioritizing less recently used interests)
Frequency of usage (balancing across all interests)
Relevance to the academic topic (when applicable)
Priority weighting (e.g., career aspirations receive higher weights)
Conversation continuity (maintaining the same interest throughout a thread)

The prompt engineering module 140 dynamically modifies educational prompts to incorporate the selected interest. This module applies a consistent structural modification that instructs the content generation system to incorporate the interest in a natural, relevant manner without explicitly mentioning the personalization process.

The content generation engine 150 produces the actual personalized educational content. This engine may utilize various artificial intelligence technologies, most commonly large language models, to generate explanations that incorporate the selected interest while maintaining educational accuracy.

The analytics module 160 tracks engagement metrics, learning outcomes, and the effectiveness of different interest integrations. This module provides insights to educators and continuously improves the interest selection process through a feedback loop.

### Interest Collection and Classification

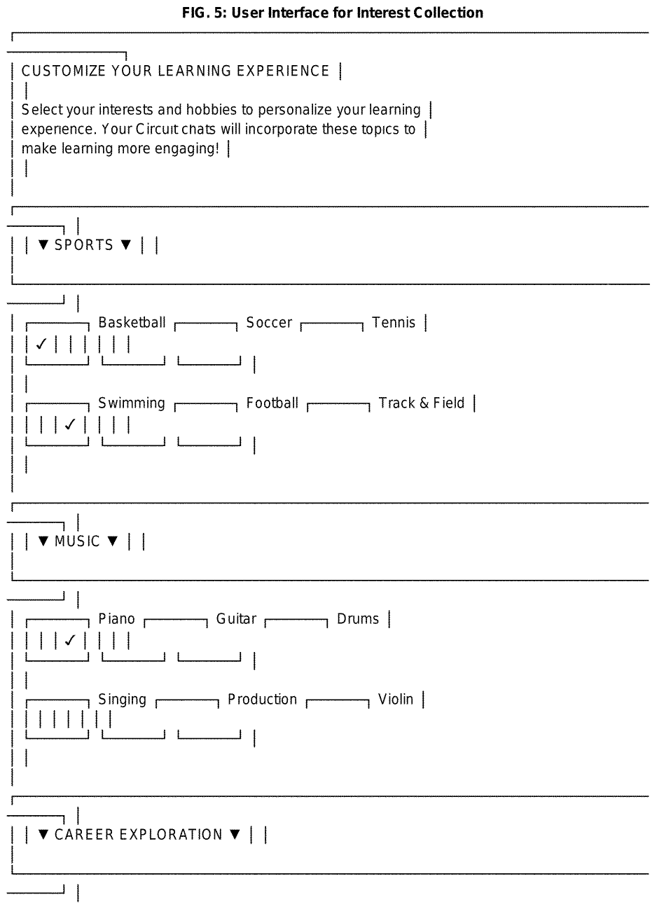

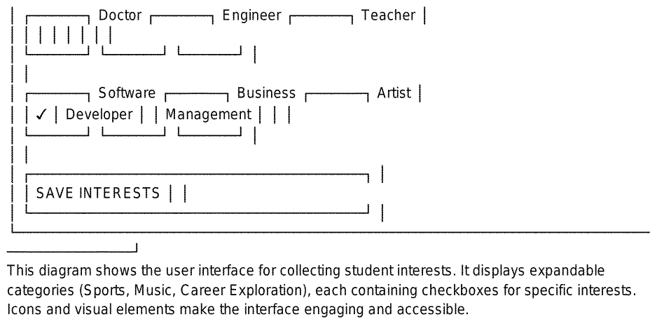

Referring to FIG. 5, a screenshot illustrates the user interface for collecting and managing student interests. The interface presents interests in expandable categories, each containing specific interest options represented with both text and visual icons for improved accessibility.
Interests are collected through a multi-step process:
Students select from predefined categories of interests
Within each category, students can select multiple specific interests
Selected interests are stored in the student's profile as an array of string values
Students can optionally designate certain interests as career aspirations
The interface allows for periodic updates as student interests evolve

The classification system organizes interests into hierarchical categories to facilitate analysis and reporting. For example, “Basketball,” “Soccer,” and “Tennis” would be classified under the broader category of “Sports.” This hierarchical structure enables both specific interest matching and category-level analysis.

### Database Implementation

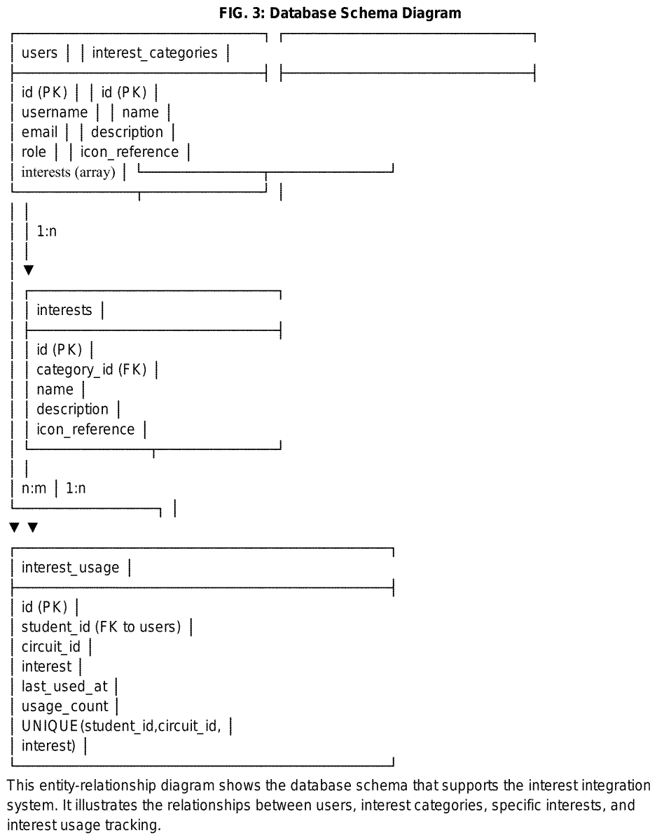

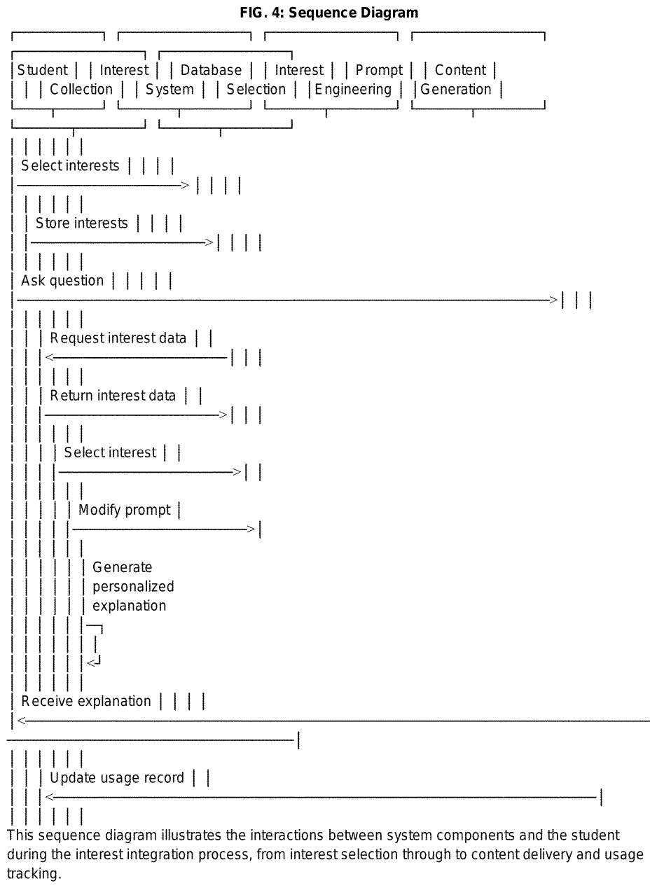

Referring to FIG. 3, a database schema diagram illustrates the data structure that supports the interest integration system. The schema includes the following key tables:

### 1. Users—Stores Basic User Information Including:

id (primary key)
username
email
role (student, teacher, admin)
interests (array of string values)

### 2. Interest_Categories—Stores the Classification Hierarchy:

id (primary key)
name (e.g., “Sports,” “Music,” “Careers”)
description
icon_reference

### 3. Interests—Stores Specific Interest Options:

id (primary key)
category_id (foreign key to interest_categories)
name (e.g., “Basketball,” “Piano,” “Software Developer”)
description
icon_reference

### 4. Interest_Usage—Tracks Interest Usage for Rotation:

id (primary key)
student_id (foreign key to users)
circuit_id (identifies the educational context)
interest (the specific interest used)
last_used_at (timestamp)
usage_count (integer tracking total usage)
UNIQUE constraint on (student_id, circuit_id, interest)

This database structure supports efficient queries for the interest rotation algorithm while maintaining referential integrity and tracking interest usage patterns.

### Interest Rotation Algorithm

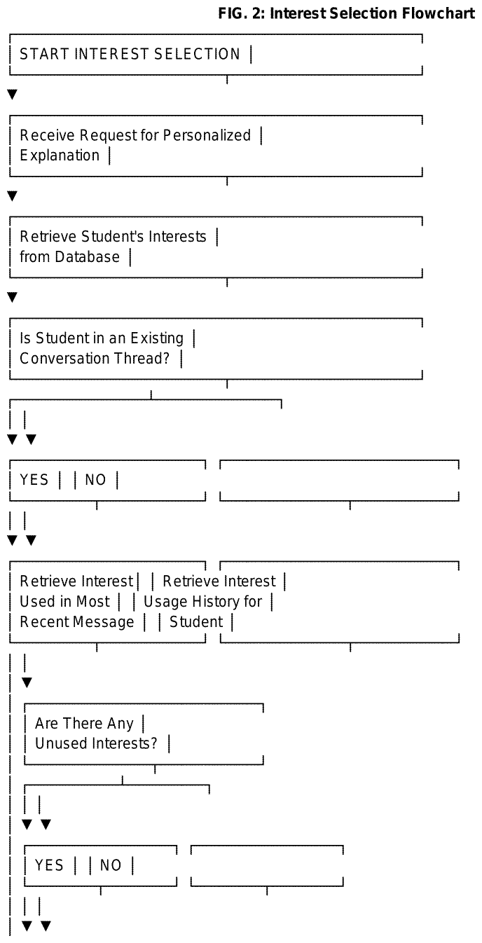

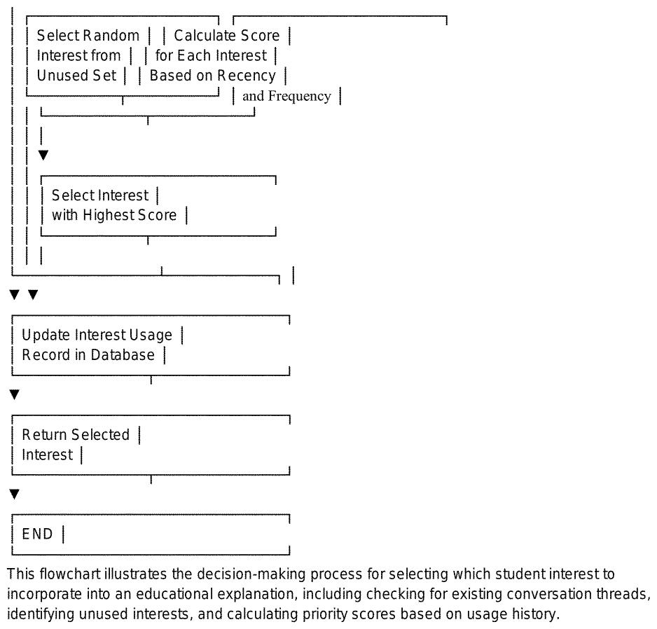

The interest rotation algorithm is a key technical innovation that ensures each student experiences diverse interest integrations over time. Referring to FIG. 2, a flowchart illustrates this selection process.

The algorithm functions as follows:

```
  function selectInterest(studentId, circuitId, availableInterests) {
  // Get usage history for this student in this circuit
  const usageHistory = database.query(
  “SELECT interest, last_used_at, usage_count
  FROM interest_usage
  WHERE student_id = ? AND circuit_id = ?”,
  [studentId, circuitId]
  );
  // If there are interests with no usage history, prioritize those
  const unusedInterests = availableInterests.filter(interest =>
  !usageHistory.find(record => record.interest === interest)
  );
  if (unusedInterests.length > 0) {
  // Randomly select from unused interests
  return unusedInterests[Math.floor(Math.random( ) *
unusedInterests.length)];
  }
  // Calculate a score for each interest based on recency and frequency
  const scoredInterests = availableInterests.map(interest => {
  const usageRecord = usageHistory.find(record => record.interest ===
interest);
  if (!usageRecord) {
  return { interest, score: 0 }; // Should not reach here due to earlier check
  }
  const daysSinceLastUsed = calculateDaysBetween(new Date( ), new
Date(usageRecord.last_used_at));
  const frequencyPenalty = usageRecord.usage_count * 2;
  // Higher score = more eligible for selection
  const score = daysSinceLastUsed − frequencyPenalty;
  return { interest, score };
  });
  // Sort by score (descending) and select the top interest
  scoredInterests.sort((a, b) => b.score − a.score);
  return scoredInterests[0].interest;
  }
```

This algorithm ensures that:
All interests are eventually used
Frequently used interests are deprioritized
Recently used interests are temporarily deprioritized
The selection maintains sufficient variety over time

For conversation continuity, the system also checks if the student is in an ongoing conversation thread. If so, it retrieves and reuses the interest from the most recent message in that thread to maintain contextual consistency.

### Prompt Engineering Technique

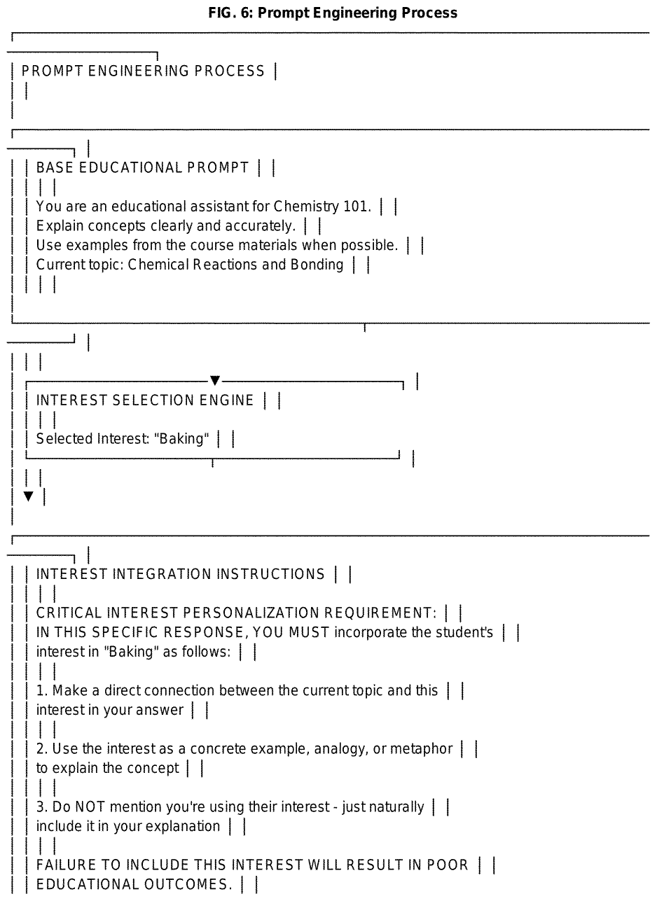

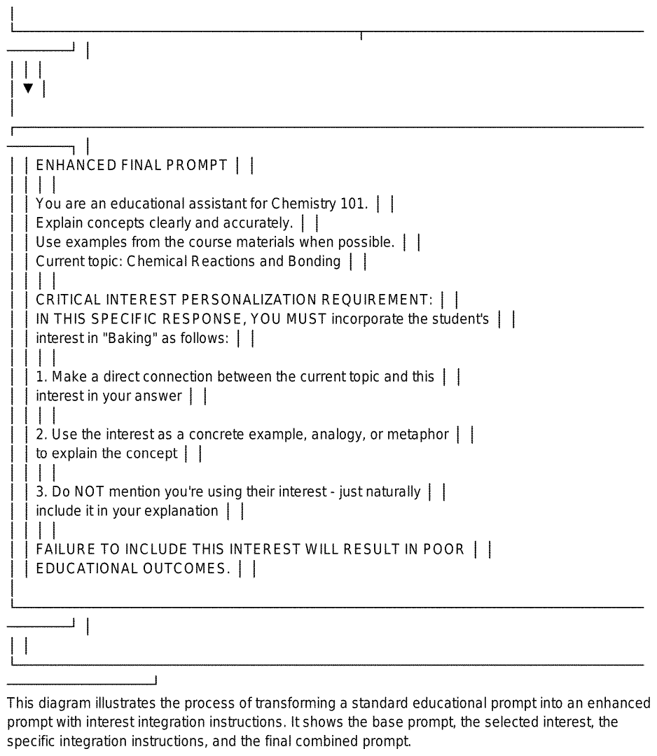

Referring to FIG. 6, a diagram illustrates the prompt engineering process that transforms standard educational prompts into interest-integrated prompts.

The prompt engineering module applies a consistent modification structure to base educational prompts:
// Base educational prompt
const basePrompt=‘You are an educational assistant for ${courseName}.

Explain concepts clearly and accurately. Use examples from the course materials
when possible. Current topic: $ {currentTopic}.’;
// Selected interest from rotation algorithm
const selectedInterest=interestRotationAlgorithm (studentId, circuitId, studentInterests);
// Enhanced prompt with interest integration
const enhancedPrompt=‘$ {basePrompt}
CRITICAL INTEREST PERSONALIZATION REQUIREMENT:
IN THIS SPECIFIC RESPONSE, YOU MUST incorporate the student's interest in “$ {selectedInterest}” as follows:
1. Make a direct connection between the current topic and this interest in your answer
2. Use the interest as a concrete example, analogy, or metaphor to explain the concept
3. Do NOT mention you're using their interest-just naturally include it in your explanation
FAILURE TO INCLUDE THIS INTEREST WILL RESULT IN POOR EDUCATIONAL OUTCOMES.’;

This prompt modification accomplishes several technical objectives:
It maintains the educational accuracy of the base prompt
It provides specific instructions for natural integration
It emphasizes that the integration should enhance rather than replace core content
It creates a consistent structure that can be applied to any educational domain

### EXEMPLARY EMBODIMENTS

The following examples illustrate the operation of the interest integration system across various academic domains and student interests:

### Example 1: Physics Concepts Through Skateboarding

When explaining Newton's Laws of Motion to a student with skateboarding interests, the system generates explanations such as:

“When you push off on your skateboard, you're demonstrating Newton's Third Law. The force you exert backward against the ground creates an equal and opposite reaction that propels you and your skateboard forward. Similarly, when you perform an ollie, the upward force you apply to the tail of your board compresses against the ground, creating an opposite reaction that launches both you and the board upward. These same principles explain why rockets can travel through space by expelling propellant in the opposite direction.”

### Example 2: Chemical Reactions Through Baking

For a student interested in baking, the explanation of chemical reactions might read:

“Chemical reactions involve breaking and forming bonds between atoms, similar to what happens when you bake cookies. When you mix baking soda (sodium bicarbonate) with acidic ingredients like buttermilk, a chemical reaction produces carbon dioxide gas, causing your cookies to rise. Heat from the oven accelerates these reactions, transforming separate ingredients into a completely new substance with different properties-just as sodium and chlorine (both hazardous separately) react to form table salt (sodium chloride), which is essential for life.”

### Example 3: Algebra Through Video Game Design

For a student interested in video game design, algebraic concepts may be explained as:

“When designing character movement in video games, developers use linear equations to calculate position. If your character moves at a constant speed of 5 pixels per second, their position (p) can be calculated with the equation p=5t+p₀, where t is time elapsed and p₀ is starting position. This same algebraic relationship lets game designers predict where enemies should appear, how projectiles travel, and how power-ups affect character abilities—all through manipulating variables in equations.”

### Example 4: Literature Analysis Through Sports

For a student athlete interested in basketball, literary analysis might be explained as:

“Analyzing the themes and character development in a novel is similar to analyzing game footage in basketball. Just as you might identify how a team's defensive strategy evolves throughout a game, you can track how the protagonist's motivations and actions evolve throughout the story. The climactic confrontation in the novel functions like a championship game-all the character development and plot tension built up to that moment. Different literary perspectives (historical, feminist, etc.) are like viewing the game from different camera angles—each revealing different aspects of the same events.”

### Example 5: Historical Events Through Music

For a student interested in music production, historical events might be explained as:

“The causes and effects of the Industrial Revolution parallel the development of modern music production. Just as the invention of steam engines and mechanized looms transformed manufacturing from artisanal to mass production, the development of digital audio workstations and sampling technologies transformed music creation from requiring full orchestras to being possible on a single computer. Both revolutions democratized their fields, created new socioeconomic classes, and fundamentally changed how their products were distributed and consumed.”

### Example 6: Ecological Concepts Through Fashion

For a student interested in fashion design, ecological concepts might be explained as:

“Ecosystem relationships function similar to sustainable fashion supply chains. Just as predator-prey relationships maintain population balances in nature, balanced sourcing of materials maintains environmental health in fashion production. When a fashion brand over-harvests a resource like cotton, it disrupts environmental systems just as removing too many predators disrupts wildlife populations. The concept of biodiversity parallels the diversity of sustainable materials in fashion, where reliance on a single fiber type creates vulnerability, while diverse material sourcing creates resilience and adaptability.”

These examples demonstrate how the system transforms standard academic content by integrating specific student interests, creating contextual relevance while maintaining educational accuracy.

### Analytics and Feedback Loop

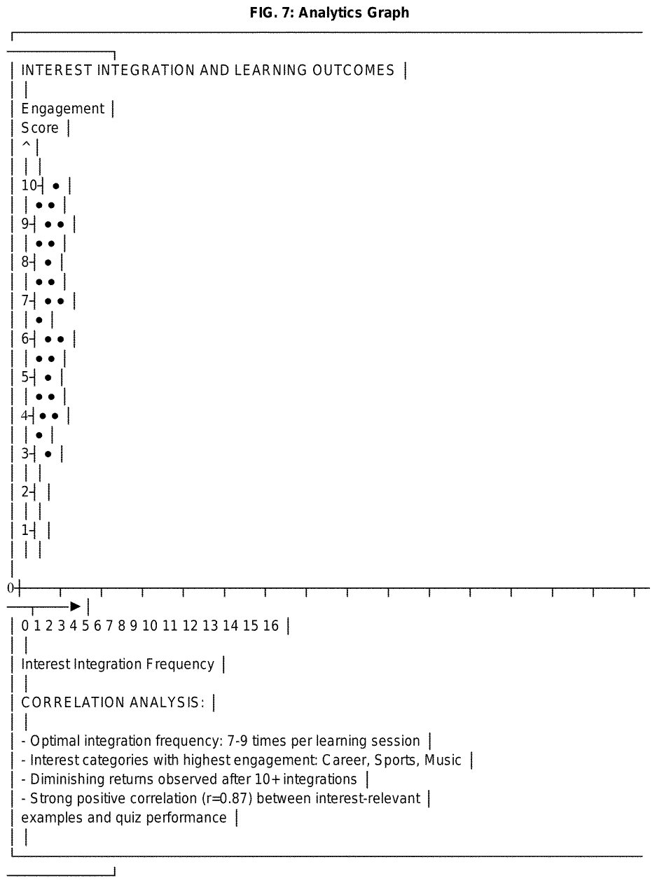

Referring to FIG. 7, a graph illustrates the correlation between interest integration frequency and student engagement metrics as tracked by the analytics module.

The analytics module collects and processes several types of data:
Interest usage frequency and patterns
Student engagement metrics (time spent, response rates, etc.)
Learning outcome measurements (quiz results, completion rates, etc.)
Interest effectiveness ratings (which interests correlate with better outcomes)

This data feeds back into the interest selection algorithm, creating a continuous improvement loop that optimizes the personalization process over time. The system identifies which interest categories are most effective for explaining specific academic concepts and uses this data to further refine the selection process.

Additionally, the analytics module generates reports for educators, providing insights into:
Most common student interests by demographic groups
Most effective interest categories for specific academic domains
Individual student interest profiles and engagement patterns
Recommendations for curriculum design based on student interest trends

### Technical Implementation Methods

The interest integration system may be implemented through various technical methods, including:

1. Cloud-based Architecture: The system can be implemented as a cloud service that integrates with existing learning management systems, providing scalability and accessibility.

2. Local Deployment: The system can be deployed within an educational institution's existing IT infrastructure, with database systems maintained on local servers.

3. Hybrid Approach: The system can use a hybrid architecture where student data is maintained locally while utilizing cloud resources for content generation.

The interest collection module can be implemented as a web application, mobile application, or integrated component within existing educational platforms. The database system can be implemented using SQL or NoSQL database technologies, with appropriate encryption and access controls to protect student data.

The interest selection algorithm and prompt engineering module can be implemented in various programming languages, with appropriate optimizations for performance and scalability. The content generation engine can leverage existing natural language processing technologies, with custom modifications to support interest integration.

### Technical Advantages

The described system provides several technical advantages over prior approaches:

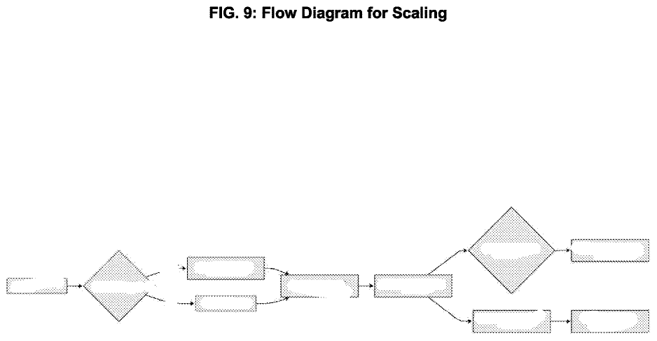

1. Scalable Personalization: Referring to FIG. 9, Unlike manual personalization methods limited by educator capacity, the system achieves O(n) scaling for personalization across unlimited students.

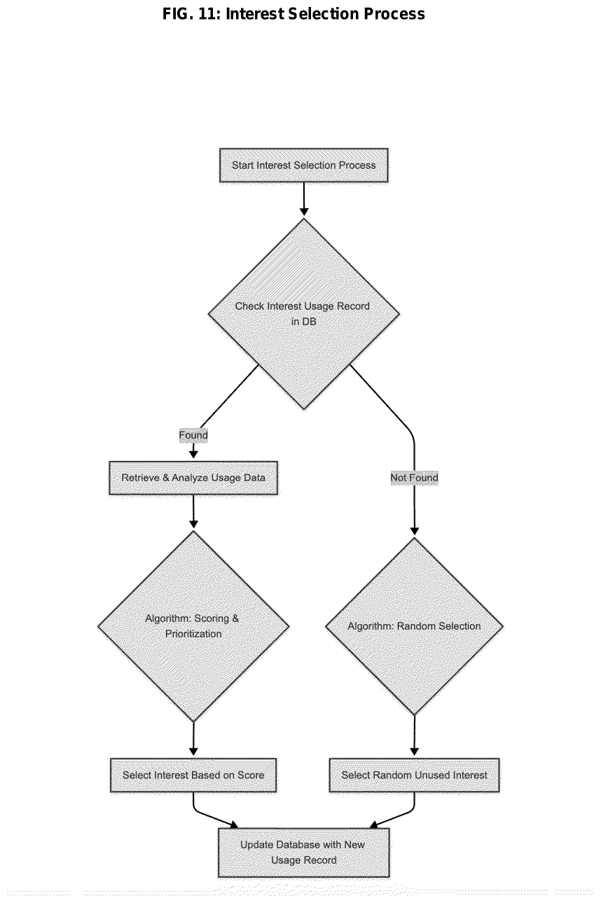

2. Interest Rotation Efficiency: Referring to FIG. 11, the rotation algorithm maintains O(1) lookup complexity for interest selection while ensuring comprehensive coverage of student interests over time.

3. Memory-Efficient Storage: By storing categorical interest labels rather than full content examples, the system minimizes storage requirements while maximizing personalization potential.

4. Adaptive Learning Curves: The system's feedback mechanisms create continuous improvement loops that optimize interest selection based on demonstrated effectiveness.

5. Cross-Domain Knowledge Transfer: The system enables interest contexts from one domain (e.g., sports) to enhance learning in unrelated domains (e.g., literature), facilitating cognitive connections that improve retention.

6. Contextual Consistency: By maintaining interest continuity within conversation threads, the system creates coherent learning narratives that build on established contexts.

7. Distributed Knowledge Integration: The system overcomes the knowledge boundary constraints of individual educators by leveraging an AI knowledge base that can accurately integrate diverse interest domains.

These technical advantages combine to solve the previously intractable problem of providing truly personalized educational content at scale, resulting in measurable improvements in student engagement, concept retention, and academic performance.

### Key Technical Components:

### Interest Storage & Selection

Each user has an interests array in their profile
Students select interests via the customize page (client/src/pages/student/customize.tsx)
Selected interests are saved to database using updateUserInterests function

### Interest Usage in Conversations

When a student starts a chat, the system:
Checks if conversation already has a used interest
If not, selects a new interest using getLeastUsedInterest function
Tracks interest usage with trackInterestUsage function
Adds the selected interest to the AI system message

### Interest Rotation Algorithm

getLeastUsedInterest function selects interests that:
Are least recently used by this student in this circuit
Or least frequently used if all have been used recently
Falls back to random selection if needed

### Database Structure

interest_usage table tracks:
Which student used which interest
In which circuit the interest was used
How many times each interest was used
When the interest was last used
chat_messages table has used_interest field to maintain consistency

### Auto-Scaling Architecture

The interest rotation system automatically scales to millions of students because:
Per-student tracking: Each student has their own interest usage records
Database indexing: Usage queries are optimized with proper indexes
Stateless design: No in-memory state that would limit scale
Client-server separation: Processing happens at request time
Efficient queries: Database operations use optimized SQL

The system ensures each student gets personalized content without any centralized bottlenecks that would limit scale.

### How Student Interests Are Embedded in Academic Explanations

### Interest Selection Process

Students select interests from predefined categories (sports, music, etc.)
Interests are stored in user's profile
Interest rotation system implemented to ensure variety
System dynamically selects interests during conversations

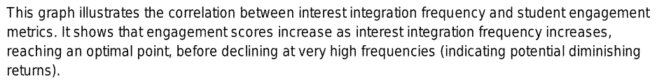

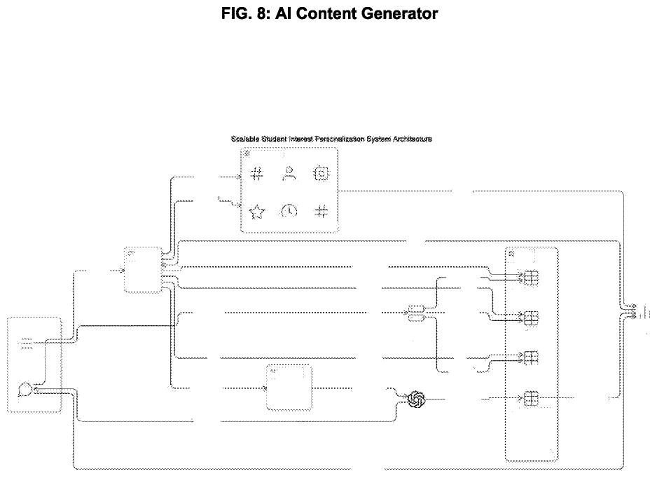

Referring to FIG. 8, a technical Implementation of Interest Embedding is disclosed.

### System Message Enhancement

The app injects specific instructions into the AI system message that handles each student query:

```
  systemMessage += ″\n\nCRITICAL INTEREST PERSONALIZATION
REQUIREMENT:″;
  systemMessage += ‘\nIN THIS SPECIFIC RESPONSE, YOU MUST
incorporate the student's interest in ″${interestToUse}″ as follows:‘;
  systemMessage += ″\n1. Make a direct connection between the current
topic and this interest in your answer″;
  systemMessage += ″\n2. Use the interest as a concrete example,
analogy, or metaphor to explain the concept″;
  systemMessage += ″\n3. Do NOT mention you're using their interest -
just naturally include it in your explanation″;
```

### Specific Embedding Techniques Required in AI Instructions

Direct connections between academic topics and student interests
Using interests as concrete examples/analogies/metaphors
Natural incorporation without mentioning the technique
Example guideline: “For explaining bonds to someone interested in basketball, say ‘Think of a bond like a contract between a basketball player and team—the team borrows the player's talent and pays them guaranteed money in return’”

### Interest Rotation Logic

getLeastUsedInterest function selects the interest that was:
Used least recently for this student in this circuit
Has the lowest usage count if multiple interests have the same last-used date
This ensures a variety of interests are used across conversations
The function checks existing usage records, or creates a random selection if none exist

### Conversation-Level Consistency

Once an interest is selected for a conversation, it's maintained throughout
The usedInterest field in the chat_messages table tracks this

### Fallback Mechanisms

If rotation system fails, a random interest is selected
If no interests available, explanation proceeds without personalization

### Interest Usage Guidelines

The system includes specific rules to ensure interests enhance academic content:
1. ONLY use interests to create analogies that EXPLAIN COURSE CONCEPTS
2. Student interests should ENHANCE explanations of academic material, not replace them
3. All analogies using student interests MUST directly explain course concepts
4. CORRECT APPROACH: If interest is “Lawyer” and teaching “5 Whys technique”-explain how lawyers use the technique to probe deeply into case details
5. INCORRECT APPROACH: Making up scenarios not related to course materials

This implementation ensures that academic content remains the focus while making explanations more engaging and relatable through personalized interest integration.

Some embodiments include “relevancy” to the selection algorithm. This is not just looking at what is available but also what could be relevant to the topic. Relevancy could be related to an interest that can be easily used to illustrate a concept versus one that doesn't connect as well or it could be related to what interest is currently being used in that session to maintain continuity.

### Technical Explanation of Interest Relevancy Determination

Relevancy is determined through how the system structures inputs and forces the model to resolve them together at generation time.

For each response, the system builds a prompt with three components:
Course Context—subject, role, and instructional constraints (what the model is teaching and how)
Conversation State—the recent message history, which defines the exact concept the student is currently working through
Interest Set—multiple user-selected interests (typically up to ~5), all provided at once as candidates

The model is explicitly instructed to select one of the provided interests and use it to explain the current concept as an analogy or example.

### How Relevancy is Actually Determined

Relevancy comes from a two-part process that happens inside the model during generation:

### 1. Selecting the Best Interest for the Concept

The model first identifies the specific concept being discussed based on the latest conversation context.

It then evaluates the available interests against that concept and effectively asks:

“Which of these can I use to explain this most clearly?”

This evaluation is based on how well each interest supports a clean, structurally accurate analogy, meaning:
Can elements of the interest map to elements of the concept?
Does it preserve the logic or relationships of the concept?
Can it be explained simply and clearly in this context?

The model selects the interest that gives it the most workable mapping.

### 2. Constructing the Analogy

Once an interest is selected, the model builds the response by mapping:
parts of the academic concept→to elements within the interest
while staying consistent with the course context and the ongoing conversation

### What “Relevancy” Means in Practice

An interest is considered relevant if it allows the model to produce an explanation that is:
Concept-specific—directly tied to what the student is asking right now
Structurally accurate—the analogy actually reflects how the concept works
Instructionally useful—it makes the concept easier to understand

Because all candidate interests are available at the same time, the one used in the response is effectively the best fit for that specific moment in the conversation.

### why it Stays Consistent

The full conversation history is included on every turn, so the model can see how it has been explaining things.

That creates natural continuity:
If a prior interest is still a good fit, it tends to reuse it
If the concept shifts, it can switch to a different interest that maps better

### Technical Explanation of Follow-Up Question Generation and Deeper Engagement

The system generates follow-up questions through a controlled response loop where each response is required to advance the student's understanding one step at a time and end with a question or task. This ensures continuous interaction and prevents one-shot explanations.

The core of the system is how those follow-up questions are constructed and adapted in real time based on context and student signals.

### How Follow-Up Questions are Determined

For each turn, the model is given:
Course Context (what is being taught and how)
Conversation State (what the student is currently working through)
Interest Set (available domains for analogy, when relevant)

The model first identifies the exact concept or step the student is on, then generates a follow-up question designed to move the student forward from that specific point.

This is done by:

### Targeting the Next Step

The model determines the smallest logical next step in the concept and forms a question that prompts the student to engage with that step (e.g., apply, predict, or explain).

### Adjusting Based on Student Signals

The system analyzes incoming messages for indicators of confusion or uncertainty. When detected, the follow-up question is adapted by:
narrowing scope (smaller step)
increasing guidance (more directed question)
adding intermediate checks for understanding
   Escalating with Interest-Based Framing (When Effective)

When confusion is detected—or when the model determines that an analogy would improve clarity—the system incorporates a user interest into the follow-up question.

At this point, the model:
evaluates available interests as candidate domains
selects the one that best maps to the current concept
uses it to reframe the question in a more intuitive, concrete way

This results in follow-up questions that:
extend an analogy already introduced
ask the student to reason within the interest domain
prompt the student to apply the concept using that familiar context
Interest injection is used when it improves the student's ability to engage with or understand the next step.

### Resulting Behavior

The system produces follow-up questions that are:
Step-specific—tied to the exact point in the learning process
Adaptive—simplified or expanded based on student understanding
Progressive—guiding the student through a sequence of reasoning steps
Contextually grounded—optionally framed through relevant user interests when it enhances clarity

### Scaling Architecture for Interest Injection System for Millions of Students

The architecture for interest injection in academic explanations is built to scale to millions of students. Here's a detailed explanation of how this works:

### Database Layer Scalability

### Optimized Schema Design

The interest_usage table uses a compound index on (studentId, circuitId, interest) with a unique constraint
This ensures efficient queries even with millions of records
Database indexes are designed to support the specific query patterns in getLeastUsedInterest

### Efficient Query Patterns

Queries target only the specific student-circuit combination
The inArray filter limits results to only relevant interests
Ordering by lastUsedAt and usageCount leverages indexes for fast retrieval
No full table scans that would limit scale

### Connection Pooling

The app uses a PostgreSQL connection pool to handle concurrent requests
Pool size can be adjusted based on load without code changes
Prevents connection exhaustion under high load

### Application Architecture Scalability

### Stateless Processing

Interest selection happens at request time, not stored in memory
No shared state between user sessions that would create bottlenecks
Each request is processed independently, allowing horizontal scaling

### Request-Time Interest Selection

Interest selection and injection happen at request time
No pre-processing or batch operations that would create queuing

Database operations are minimal and focused on specific student/circuit data

### Caching Strategy

The current architecture allows for implementing Redis caching for frequently accessed interest records
Could add edge caching for student profiles with interest information
Schema supports adding caching without design changes

### Failure Handling for Scale

### Graceful Degradation

If interest selection fails, system falls back to random selection
If all selection fails, explanation proceeds without personalization
Ensures user experience continues even under extreme load
Error Isolation
Error in interest selection doesn't affect the core chat functionality
Detailed error logging helps identify scaling bottlenecks
Isolated database operations prevent cascading failures

### Scaling Operations

### Isolated Database Operations

Interest usage tracking is separate from content retrieval
Database operations can be moved to background processing if needed

The design allows for eventual consistency in tracking with no user impact

### Horizontal Scaling Capabilities

The design supports sharding by student/circuit combinations
No global state or aggregation requirements in the critical path
Each user's interests and usage patterns are siloed from others

This architecture ensures that each student gets consistently personalized content even as the system scales to millions of users, with no central bottlenecks or degradation in personalization quality.

### Scalable Interest Personalization System

The application uses a sophisticated system to personalize educational content based on millions of student interests in circuit chats. Here's how it works:

### 1. Database Schema Design

User Interest Storage: Student interests are stored as a JSON array in the users tableinterests: json (“interests”). $type<string[ ]>( )default([ ])

Interest Usage Tracking: The system uses a dedicated interest_usage table with a scalable design: export const interestUsage=

pgTable(“interest_usage”, {
id: serial(“id”).primaryKey( ),
studentId: integer(“student_id”).notNull( ),
circuitId: integer(“circuit_id”).notNull( ),
interest: text(“interest”).notNull( ),
lastUsedAt: timestamp(“last_used_at”).notNull( ).defaultNow( ),
usageCount: integer(“usage_count”).notNull( ).default(1),
}, (table) => {
return {
uniqueStudentCircuitInterest: unique( ).on(table.studentId,
table.circuitId, table.interest)
};
});

Chat Message Tracking: The chat_messages table includes an usedInterest column to track which interest was used in each conversation

### 2. Interest Rotation Algorithm

The system uses a sophisticated rotation algorithm to prevent repetitive use of the same interests:

async getLeastUsedInterest(studentId: number, circuitId: number,
availableInterests: string[ ]): Promise<string | null> {
try {
// Get usage records for all available interests for this student-circuit pair
const usageRecords = await db.select( )
from(interestUsage)
.where(and(
eq(interestUsage.studentId, studentId),
eq(interestUsage.circuitId, circuitId),
inArray(interestUsage.interest, availableInterests)
))
.orderBy(interestUsage.lastUsedAt, interestUsage.usageCount);
// Find interests that have never been used
const usedInterests = new Set(usageRecords.map(record =>
record.interest));
const unusedInterests = availableInterests.filter(interest
=> !usedInterests.has(interest));
// If there are unused interests, return one of them randomly
if (unusedInterests.length > 0) {
return unusedInterests[Math.floor(Math.random( ) *
unusedInterests.length)];
}
// Otherwise, return the least recently used interest
return usageRecords[0].interest;
} catch (error) {
// In case of error, return a random interest to avoid breaking the chat
return availableInterests[Math.floor(Math.random( ) *
availableInterests.length)];
}
}

### 3. Interest Usage Tracking

The system maintains a record of how often each interest has been used:
async trackInterestUsage(studentId: number, circuitId: number, interest: string):

Promise<InterestUsage> {
try {
// Check if we already have a record for this student-circuit-interest
combination
const existingRecord = await db.select( )
.from(interestUsage)
.where(and(
eq(interestUsage.studentId, studentId),
eq(interestUsage.circuitId, circuitId),
eq(interestUsage.interest, interest)
))
.limit(1);
if (existingRecord.length > 0) {
// Update the existing record
const [updatedRecord] = await db.update(interestUsage)
.set({
lastUsedAt: new Date( ),
usageCount: existingRecord[0].usageCount + 1
})
.where(eq(interestUsage.id, existingRecord[0].id))
.returning( );
return updatedRecord;
} else {
// Create a new record
const interestUsageData = {
studentId,
circuitId,
interest,
lastUsedAt: new Date( ),
usageCount: 1
};
const [newRecord] = await db.insert(interestUsage)
.values(interestUsageData)
.returning( );
return newRecord;
}
} catch (error) {
throw error;
}
}

### 4. Conversation Continuity

The system ensures consistent interest usage throughout a conversation by tracking which interest was used in previous messages:
// First check if we already have a used interest from earlier in the conversation let interestToUse=previousUsedInterest;
// If no interest has been used yet in this conversation, select a new one

if (!interestToUse) {
try {
// Get the least used interest for this student in this circuit
const selectedInterest = await storage.getLeastUsedInterest(
result.data.studentId,
result.data.circuitId,
studentInterests
);
// If we got a valid interest, track its usage
if (selectedInterest) {
// Track that we're using this interest
await storage.trackInterestUsage(
result.data.studentId,
result.data.circuitId,
selectedInterest
);
interestToUse = selectedInterest;
}
} catch (error) {
// If there's an error in the rotation system, fall back to choosing a random
interest
interestToUse = studentInterests[Math.floor(Math.random( ) *
studentInterests.length)];
}
}

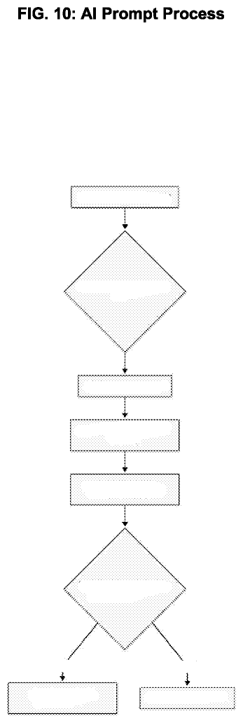

Referring to FIG. 10, an OpenAI Prompt Enhancement is explained.

The interest is injected into the OpenAI system message with specific instructions:
// Add the selected interest to the system message
systemMessage+=“\n\nCRITICAL INTEREST PERSONALIZATION REQUIREMENT:”;
systemMessage+=‘\nIN THIS SPECIFIC RESPONSE, YOU MUST incorporate the student's interest in “$ {interestToUse}” as follows:’;
system Message+=“\n1. Make a direct connection between the current topic and this interest in your answer”;
systemMessage+=“\n2. Use the interest as a concrete example, analogy, or metaphor to explain the concept”;
systemMessage+=“\n3. Do NOT mention you're using their interest—just naturally include it in your explanation”;
systemMessage+=“\n4. For example, if explaining bonds to someone interested in basketball, you might say ‘Think of a bond like a contract between a basketball player and team—the team borrows the player's talent and pays them guaranteed money in return”;

### 6. Scalability Features

The system includes several features that ensure unlimited scalability:

Database Indexing: The interest_usage table has a unique constraint on (studentId, circuitId, interest) for efficient lookups.

Fault Tolerance: The algorithm includes fallbacks at every step to ensure it never breaks://In case of error, return a random interest to avoid breaking the chat
const fallbackInterest=availableInterests.length>0?
availableInterests[Math.floor(Math.random( )*availableInterests.length)]
: null;
Performance Optimization: The system uses database queries with proper indexing and limits to handle millions of records efficiently
Edge Case Handling: Special handling for single interests, empty interests, and error scenarios ensures the system continues to function under any circumstances
Migration Support: The system includes migration scripts to maintain database integrity as the platform scales

### 7. Database Structure Benefits

The chosen database structure offers several key scalability advantages:
Separation of Concerns: By keeping interest usage separate from chat messages, the system avoids large table bloat
Efficient Queries: The structure allows for targeted queries that only retrieve the minimal necessary data
Statistical Analysis: The usage counts enable analytical insights into which interests are most effective
Horizontal Scaling: The database design supports standard horizontal scaling patterns used in cloud databases

This architecture ensures the system can scale to support millions of students, each with their own unique set of interests, while maintaining high performance and reliability.

### Expanded Technical Detail on Interest Selection and Application Logic

When interest-based framing is triggered, the system passes the full Interest Set as part of the prompt and includes an instruction requiring the model to select one interest for use in the response.

At generation time, the model resolves this as a structured selection process that can be described as:

### Inputs:

C₁: Course Context
C₂: Conversation State (latest messages)
I={i₁, i₂, i₃, . . . iₙ}: Set of candidate interests

### Step 1: Extract Target Concept

Parse C₂ to identify the current concept, question, or point of confusion
Define this as targetConcept

### Step 2: Evaluate Candidate Interests

For each interest i in I:
Attempt to construct a conceptual mapping between targetConcept and i
Evaluate:
   a) Element alignment (can components of targetConcept map to elements in i)
   b) Relationship preservation (does the mapping maintain the logic/structure of targetConcept)
   c) Simplicity (can this mapping be expressed clearly at the current step)

### Step 3: Determine Mapping Feasibility

Discard candidates where mapping fails (no clear alignment or breaks concept logic)
For remaining candidates, estimate relative quality of mapping based on:
   directness of analogy
   clarity of explanation
   usefulness for advancing the next step

### Step 4: Select Interest

Select i* where mappingFeasibility(i*) is maximized

### Step 5: Generate Follow-Up Question

Construct response using i* by:
   translating targetConcept→interest domain (i*)
   embedding this mapping into the explanation
   generating a follow-up question that operates within the same mapping

### Execution Behavior

The selection and question generation occur in a single inference pass
The model's selection is reflected only in the chosen interest used in the final response shown to the user
The process is repeated on each turn using updated conversation state

### Implementation Constraints

This logic is enforced through prompt constraints, all of which are required to be satisfied simultaneously

At runtime, the application constructs a prompt that functions as a bounded constraint environment for the model. This environment includes:

### Input Constraints

A finite set of candidate interests: I={i₁, i₂, . . . , iₙ}

The current target concept derived from conversation state: targetConcept
Instructional rules (one-step progression, question required, etc.)

### Selection Constraint

The prompt includes an explicit requirement that the model must:
select exactly one interest from the provided set I
use that selected interest as the basis for explanation

This converts interest selection into a closed-set selection problem rather than an open-ended generation task.

### Mapping Constraint

The model is required to construct an analogy or example where:
elements of targetConcept are mapped to elements within the selected interest
the underlying relationships of the concept are preserved

This enforces structural alignment, not just mention or reference.

### Response Constraint

The output must simultaneously:
explain the current concept step
remain consistent with course context
include a follow-up question or task

### Optimization Pressure (Implicit)

Because all constraints must be satisfied in a single response, the model is implicitly forced to:
prefer interest candidates that allow a valid mapping
avoid candidates that would break coherence or clarity

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method for providing personalized educational content, comprising:
receiving and storing data representing a plurality of student interests;
detecting when a student requests an explanation of an academic concept;
enforcing one or more unique constraints on the request for efficient lookup;
selecting an interest from the student's stored interests using a rotation algorithm that prioritizes interests based on usage frequency and recency;
modifying an educational prompt to include instructions for incorporating the selected interest;
programming one or more fallbacks at every step to prevent breaks, wherein the fallbacks are configured for returning a random interest to avoid breaking the chat;
generating a personalized explanation of the academic concept that incorporates the selected interest as a context, example, or analogy; and
delivering the personalized explanation to the student, wherein:
there is no in-memory state that would limit scale;
rotation algorithm maintains O(1) lookup complexity for interest selection; and
there is client-server separation so processing happens at request time.

2. The method of claim 1, wherein the step of selecting an interest comprises:
retrieving historical interest usage data indicating which interests have been previously used in explanations for the student;
calculating a priority score for each interest based on a weighted combination of days since last usage and total usage frequency;
selecting the interest with the lowest usage or that has not been recently used; and
updating the historical interest usage data to reflect the current usage.

3. The method of claim 1, wherein the step of modifying an educational prompt comprises:
maintaining a base educational prompt containing accurate academic content;
applying a supplemental instruction that directs an AI system to incorporate the selected interest in a naturalistic manner;
specifying that the interest should be incorporated through relevant examples, analogies, or contextual framing; and
instructing that the interest integration should enhance rather than replace the core academic content.

4. The method of claim 1, further comprising:
tracking engagement metrics associated with each interest integration;
identifying correlations between specific interest categories and improved learning outcomes;
generating reports for educators showing which interests are most effective for explaining specific academic concepts; and
using this data to optimize future interest selection for similar academic concepts.

5. The method of claim 1, wherein receiving and storing data representing a plurality of student interests comprises:
presenting a user interface with categorized interest options;
allowing the student to select multiple interests across different categories;
allowing the student to designate certain interests as career aspirations; and
storing the selected interests in a database associated with the student's profile.

6. The method of claim 1, wherein generating a personalized explanation comprises:
providing the modified educational prompt to a natural language processing system;
receiving a generated explanation that incorporates the selected interest; and
verifying that the explanation maintains educational accuracy while successfully incorporating the interest.

7. The method of claim 1, further comprising:
tracking which interest was used in a conversation thread;
using the same interest for subsequent messages in the same conversation thread to maintain contextual consistency; and
selecting a different interest only when a new conversation thread begins.

8. A system for interest-based educational content personalization comprising:
a user interface for collecting and managing student interests;
a database structure for storing interests and tracking their usage;
an interest rotation algorithm that ensures variety in personalization;
a prompt engineering module that modifies AI instructions to incorporate selected interests; and
an analytics engine that measures the effectiveness of interest integration, wherein:
there is no in-memory state that would limit scale;
a rotation algorithm maintains O(1) lookup complexity for interest selection; and
there is client-server separation so processing happens at request time.

9. The system of claim 8, wherein the database structure comprises:
a user table storing student profiles with arrays of selected interests;
an interest_categories table defining hierarchical interest classification;
an interests table defining specific interest options within categories; and
an interest_usage table tracking which interests have been used for which students in which educational contexts.

10. The system of claim 8, wherein the interest rotation algorithm:
prioritizes interests that have not been previously used;
calculates a score for each interest based on recency and frequency of usage;
deprioritizes recently used interests to ensure variety; and
maintains the same interest throughout a conversation thread.

11. The system of claim 8, wherein the prompt engineering module:
maintains a library of base educational prompts for different academic domains;
applies a consistent modification structure to incorporate interest instructions;
specifies that interests should be incorporated naturally without explicit mention; and
ensures that the core educational content remains accurate and comprehensive.

12. The system of claim 8, wherein the analytics engine:
tracks correlations between interest categories and engagement metrics;
identifies which interests are most effective for specific academic concepts;
generates visualizations showing interest effectiveness patterns; and
provides recommendations for optimizing interest selection.

13. The method of claim 1, further comprising overcoming the personalization limitations of traditional educational systems, by:
collecting interest data from a plurality of students across multiple interest categories;
storing the interest data in a database structure that facilitates efficient retrieval;
implementing an interest rotation algorithm that ensures varied personalization over time;
dynamically modifying educational prompts to incorporate selected interests;
generating personalized educational content that connects academic concepts to student interests; and
tracking the effectiveness of different interest integrations to optimize future selections, wherein:
there is no in-memory state that would limit scale;
a rotation algorithm maintains O(1) lookup complexity for interest selection; and
there is client-server separation so processing happens at request time.

14. A non-transitory computer-readable medium storing instructions that, when executed by a processor, cause the processor to perform a method for personalizing educational content, the method comprising:
receiving and storing data representing a plurality of student interests;
detecting when a student requests an explanation of an academic concept;
selecting an interest from the student's stored interests using a rotation algorithm;
modifying an educational prompt to include instructions for incorporating the selected interest;
generating a personalized explanation that incorporates the selected interest; and
delivering the personalized explanation to the student, wherein:
there is no in-memory state that would limit scale;
a rotation algorithm maintains O(1) lookup complexity for interest selection; and
there is client-server separation so processing happens at request time.

15. The non-transitory computer-readable medium of claim 14, wherein the method further comprises:
maintaining a database of interest usage patterns;
tracking which interests correlate with improved learning outcomes;
adjusting the interest selection algorithm based on effectiveness data; and
generating reports showing interest effectiveness patterns for educators.
